(19) United States
(12) Patent Application Publication
(10) Pub. No.: US 2009/0134987 A1
(43) Pub. Date: May 28, 2009

(54) Motor Vehicle Having a Rear-end Impact Warning Device

(75) Inventors: Volker Oltmann, Calw (DE); Bernd Woltermann, Fellbach (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/097,456

(22) PCT Filed: Dec. 13, 2006
(86) PCT No.: PCT/EP2006/011981

§ 371 Date: Oct. 27, 2008

(30) Foreign Application Priority Data
Dec. 14, 2005 (DE) 10 2005 059 688.6

(51) Int. Cl. B60Q 1/30

(52) U.S. Cl. 340/435

(57) ABSTRACT

A motor vehicle has a rear-end impact warning device, which determines at least the distance to a following vehicle from the backscatter of a signal by means of a surroundings sensor system which is arranged at the rear of the vehicle. The rear-end impact warning device outputs light signals in a situation-dependent flashing mode by means of lights (e.g., brake lights) at the rear in order to provide the traffic behind with a warning of a rear-end impact if a following vehicle approaches to a critical distance. A braking process is sensed by means of a deceleration-sensing means, and a brake flashing mode is predefined if a vehicle approaches to a critical distance and at the same time a braking process is occurring.

### BACKGROUND AND SUMMARY OF THE INVENTION

This application is a national stage of International Application No. PCT/EP06/011981, filed Dec. 14, 2005, which claims priority under 35 U.S.C. §119 to German Patent Application No. 10 2005 059688.6, filed Dec. 14, 2005, the entire disclosure of which is herein expressly incorporated by reference.

The invention relates to a motor vehicle having a rear-end impact warning device.

The prior art has disclosed a number of steps for automatically providing a warning of a rear-end impact, in which the traffic traveling behind the vehicle in question is observed by means of a surroundings sensor system. The operator of the following vehicle is warned by flashing rear lights if there is risk of a rear-end impact accident because his or her vehicle approaches to a critical distance.

German patent document DE 44 06 339 A1 discloses a motor vehicle having a rear-end impact warning device that has a surroundings sensor system arranged at the rear of a vehicle. At least the distance from a vehicle traveling behind is determined from the backscatter of an emitted signal, and if a vehicle approaches to a critical distance a warning device is activated. For example, the warning may comprise flashing actuation of rear lights, such as brake lights. The flashing frequency becomes higher here the more closely the vehicle traveling behind approaches, or the higher the speed with which it approaches the vehicle traveling in front. When the brake is activated, the normal, continuous light is generated.

A comparable device is also disclosed in U.S. Pat. No. 5,760,708. The frequency of the warning signal which is output increases proportionally to the relative speed of the vehicle traveling behind which approaches the rear of the vehicle in question. In a first warning stage, only a central brake light is activated in a flashing mode. If no reaction occurs, the outer brake lights of the vehicle are also activated to flash in a second warning stage.

In German patent document DE 103 28 755 A1, a surroundings sensor system measures the distance and relative speed of a vehicle traveling behind, and optical warning signals are output to the vehicle traveling behind in accordance with a hazard potential which is determined. The number of light segments, the frequency, the luminous intensity and/or time period of the optical signals, for example from brake lights, can be varied in accordance with the hazard potential. A state of the roadway which has been determined (rain, snow, ice, soiling) and external weather conditions can be included in the determination of the hazard potential.

In addition, vehicles with an adaptive brake light which outputs a red flashing warning light in an emergency braking situation instead of the conventional brake light are known, and German patent document DE 199 52 408 A1 discloses how traffic traveling behind can be warned by means of flashing with brief light pulses which is perceived only subconsciously (subliminal warning).

One object of the present invention is to provide a motor vehicle warning system which better avoids rear-end impact accidents.

This and other objects and advantages are achieved by the rear end impact warning device according to the invention, in which light signals are output in a situation-dependent brake flashing mode by means of lights at the rear of the vehicle (such as brake lights) to the traffic behind if a following vehicle approaches to a critical distance while a braking process is occurring at the same time. In the text which follows the invention is implemented in conjunction with brake lights. However, the invention can also be applied to any type of rear lights, and to any type of warning device which warns the driver of the vehicle traveling behind by means of flashing brake lights when there is a risk of a rear-end impact. In this respect, reference is made to the prior art described above.

An advantage of the invention is that a rear-end impact warning by flashing the brake lights in a warning mode occurs in particular if the risk of a rear-end impact accident is increased by the fact that the driver's own vehicle is experiencing deceleration due to a braking process, via either the wheel brakes or engine brake (engine drag), when a driver intentionally requests a braking operation. However, unintentional decelerations, such as when the gradient of the roadway changes or the properties of the roadway change, can also be included so that a warning can also be output in these cases. Decelerations which are brought about by an autonomous braking intervention of a predictive surroundings sensor system can also be included.

The invention also avoids a situation in which the brake lights go into a continuously lit mode—which would suppress the rear-end impact warning function—when the brakes are activated and at the same time there is a risk of a rear-end impact. In such a situation, the traffic traveling behind would only then be warned of braking by the vehicle traveling in front, and there would no longer be an indication that the vehicle was approaching to a critical distance.

In one refinement, the brake lights do not output any light signals if a motor vehicle approaches a critical distance when there is a risk of a rear-end impact, but a braking process is not occurring. This has the advantage that the warning of a rear-end impact does not occur unnecessarily frequently but rather only in particularly critical situations if at the same time the driver's own vehicle (which is traveling in front) brakes.

Alternatively, in this case, the brake lights output a warning in a pre-warning mode which can be differentiated from the brake flashing mode and can have a relatively weak warning character.

The type of warning strategy may have different forms depending on the technical equipment of the driver's own vehicle in terms of the brake lights.

In one refinement, in the brake flashing mode the luminous intensity of the brake lights is switched with a predefined flashing frequency between two luminous intensity levels L_b and L_c. If a pre-warning mode is provided, the luminous intensity of the brake lights is switched with a predefined pre-warning frequency between 0 and a luminous intensity L_a in this case. In order to graduate the warning character, a higher flashing frequency may be selected than the pre-warning frequency.

At least two of the luminous intensity levels L_a, L_b, L_c should be different. In particular, L_b and L_c should be different so that continuous light does not appear in the brake flashing mode. In order to graduate the warning character, L_c>L_a should apply. The luminous intensity levels L_b and L_c can also depend on the intensity of the braking process. The luminous intensity levels L_a, L_b, L_c of the rear-end impact warning can also be varied by the severity of a determined risk of rear-end impact. This refinement of the warning is particularly suitable in the case of vehicles which are equipped with brake lights whose light sources are capable of representing at least 2 different luminous intensity levels. This may be done, for example, by means of LEDs or also by dimmable incandescent bulbs.

In one refinement, in the case of brake lights which are composed of a plurality of light units, the different luminous intensity levels are brought about by the fact that only a proportion of the light units which corresponds to the desired luminous intensity is actuated. This is an advantageous refinement if the light units can represent only one luminous intensity level, for example LED brake lights, or a brake light with two incandescent filaments or with a plurality of incandescent bulbs. In the case of a warning without braking of the driver's own vehicle, some of the light units are used in a flashing fashion. If the driver's own vehicle brakes, all the light units of the brake lights are actuated in a flashing fashion.

In the case of a vehicle with two outer brake lights and a third, for example, middle brake light, in the brake flashing mode the two outer brake lights and the third brake light are actuated with the same cycle or with opposing cycles. This means that in the case of a warning of a rear-end crash with braking of the driver's own vehicle, all three brake lights are used in a flashing fashion. It is possible for alternating flashing of the middle brake light and of outer brake lights to occur (on on the outside, then middle one off and vice versa).

In addition, in the pre-warning mode only the third brake light could be actuated in a flashing fashion. Alternatively, the third brake light could be actuated continuously, because such isolated actuation of the third brake light can be differentiated from a braking operation. If the driver brakes his own vehicle, all three brake lights are used in a flashing fashion.

A fog light, which would be correspondingly activated, can also be used as a third brake light. So that the traffic traveling behind is not blinded, the light must either be dimmed or its luminous intensity attenuated through a corresponding selection of flashing frequencies and patterns. This light can also be used as a spare light, for example in the event of a failure of another light (e.g., a failed third brake light).

To graduate the warning character further according to the pre-warning mode and brake flashing mode, the following embodiments are advantageous:

The flashing patterns in the brake flashing mode and in the pre-warning mode may be differentiated at least according to the time period of the “ON” flashing phase. In particular in the brake flashing mode the time period of an “ON” flashing phase may be selected to be longer than or equal to that in the pre-warning mode.

Alternatively or additionally, the flashing patterns in the brake flashing mode and in the pre-warning mode may be differentiable according to the time ratio between the “ON” and “OFF” flashing phases. In particular, the time ratio can be >1 in the brake flashing mode and <1 in the pre-warning mode.

As a result, when the driver's own vehicle is not being braked, it is possible, for example, for all three brake lights to be represented in a flashing mode with the same time period for “ON”/“OFF”. Alternatively, the time period for “ON” brake light could be made shorter than for “OFF” brake light. If the driver brakes his own vehicle, the time period for “OFF” brake light can then be significantly shorter than for “ON” brake light.

Alternatively or additionally, in the brake flashing mode and in the pre-warning mode, the flashing light signals can be output with different frequencies, with the frequency in the brake flashing mode (warning with braking of the driver's own vehicle) is higher than in the pre-warning mode (warning without braking of the driver's own vehicle). In the case of brake lights which are each composed of a plurality of light units (for example LED brake lights), some of the light units can be used in a flashing fashion in the case of a warning without braking of the driver's own vehicle. In the case of a warning with braking of the driver's own vehicle, the entire brake lights are used and some of the brake lights are used in alternately flashing fashion.

In trial series it has become apparent that brake lights which flash four times as quickly as the yellow flashing hazard warning lights of a flashing hazard warning system can be activated manually, have proven particularly effective at warning following traffic of a rear-end impact accident. Therefore, in the brake flashing mode or in the pre-warning mode the flashing light signals are advantageously output with a frequency which is approximately four times as high as the flashing frequency of a flashing hazard warning system which can be activated manually.

In vehicles which have a device for detecting an emergency braking situation in order, for example, to apply an increased braking pressure to the brake system or to initiate preventive PRE-SAFE® safety measures in such situations if necessary, it is advantageous if an emergency braking situation is indicated in the same brake flashing mode (emergency brake flashing) as the rear-end impact warning with simultaneous braking. As a result, the statements made above with respect to the formation of the rear-end impact warning apply analogously to emergency braking flashing in an emergency braking situation (for example owing to a deceleration limiting value being exceeded as a function of the coefficient of friction or owing to a pedal pressure/braking pressure being exceeded). This has the advantage that an identical warning is always output whenever a braking maneuver of the vehicle traveling in front is associated with an increased risk for the traffic traveling behind.

It is also possible to configure the intensity of the warning in accordance with the evaluation of the hazardous situation. For example, flowing profiles in the flashing frequency are conceivable. The flashing duration, the flashing frequency, the division of the light/dark phases, the brightness or the size of the area of the deceleration warning light which lights up is varied depending on the level of the hazard value which is determined. In particular, the flashing frequency can rise with the hazard potential.

Mixed forms of the methods described above for specific embodiments of brake lights are also possible.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a vehicle with a surroundings sensor system that is directed towards the rear; and

FIG. 2 shows the luminous intensity L plotted over the time t for various flashing patterns in various traveling situations I, II, III.

### DETAILED DESCRIPTION OF THE DRAWINGS

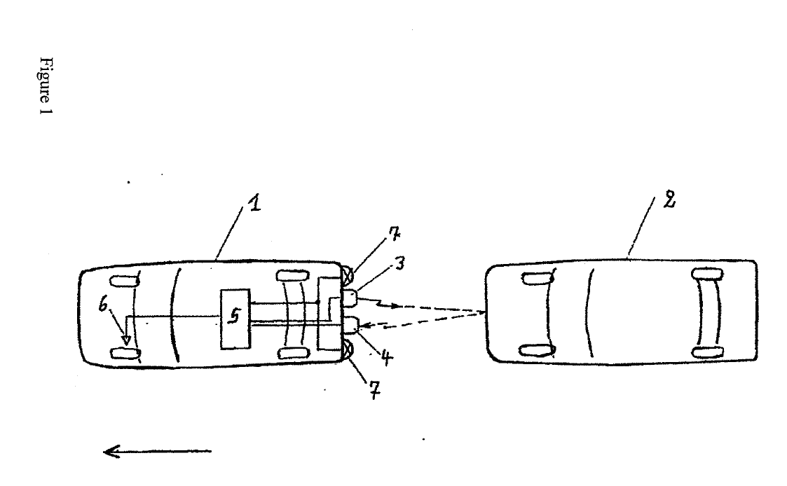

FIG. 1 shows two vehicles 1 and 2 which are traveling one behind the other, the arrow indicating the direction of travel. The vehicle 1 which is traveling in front has a transmitter 3 and receiver 4 which are right next to one another on its rear end and constitute the surroundings sensor system. For the technical details of the signal processing and for the detection of a critical approach, which are known to those skilled in the art, reference is made to German patent document DE 44 06 339 A1 and the further prior art cited hereinabove.

The information as to whether a braking process is occurring, obtained by means of a deceleration-sensing means 6, is also included in the evaluation as to whether a critical situation is present. In order to determine a braking process, the activation of the brake pedal, the braking pressures and/or the release of the accelerator pedal, the speed of the vehicle, the deceleration of the vehicle and the deceleration time period are monitored.

When the critical conditions are reached (for example when a critical distance and/or a critical relative velocity with respect to the vehicle traveling behind are reached), the control unit 5 activates the brake lights 7 according to the method described below in order to warn the vehicle traveling behind against traveling too close or of an imminent collision.

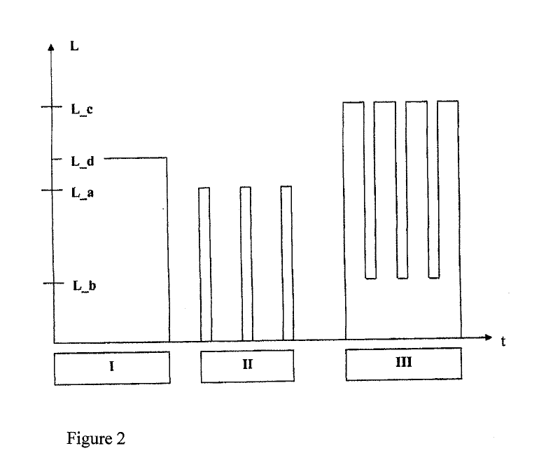

FIG. 2 shows the luminous intensity of the brake lights 7 plotted over the time t for various flashing patterns in various travel situations I, II, III.

Travel situation I represents a “standard braking situation”, i.e., braking without a particular hazard potential for the traffic behind. It is indicated by the conventional brake light as a continuous light with a specific luminous intensity L_d.

In the travel situation II, the driver does not brake his own vehicle but a vehicle traveling behind approaches his vehicle to a critical distance. A flashing signal is output in a pre-warning mode in which the luminous intensity of the brake lights 7 is switched with a predefined pre-warning frequency between 0 and a luminous intensity L_a.

In the travel situation III, the driver brakes his own vehicle while at the same time a vehicle traveling behind approaches his vehicle to a critical distance. A flashing signal is output in a brake flashing mode in which the luminous intensity of the brake lights 7 is switched with a predefined flashing frequency between two luminous intensity levels L_b and L_c.

The ratios of the luminous intensity levels L_b<L_a<L_d<L_c and the flashing frequencies are illustrated by way of example in FIG. 2 but they correspond to a selection with a graduated warning character, as has been generally explained above. In particular, the luminous intensity levels, the flashing frequency and also the pulse duty ratio in the travel situations II and III can be influenced by a hazard evaluation such as is known from the prior art cited above, in the manner of intensifying the warning when there is an increased hazard level, by increasing the luminous intensity and flashing frequency, for example.

It is therefore possible, for example, that the flashing pattern is intensified in travel situation III if the braking force which is requested by the driver of the vehicle in question rises or exceeds a threshold. The intensity of the warning is dependent on the braking deceleration or more generally on the level of the hazard which the vehicle constitutes for traffic traveling behind. In order to determine a hazard value, the deceleration of the two vehicles is monitored, together with their velocities and relative distance, deceleration time period, release of the accelerator pedal and/or the speed of the vehicles. In order to include the state of the road (for example, black ice), the average braking pressure during the response of an anti-lock brake system (ABS) is monitored as well. If the ABS already responds when the braking pressure is low, this indicates black ice and an increased hazard level.

In another refinement, in travel situation III the flashing pattern is intensified if it becomes apparent that the braking force which is requested by the driver of the vehicle traveling behind is too low because the required braking distance is underestimated. If it is detected by means of the surroundings sensor system that the vehicle traveling behind decelerates, but does not decelerate strongly enough to avoid a collision, the warning can be intensified as a function of the additionally required braking torque. If a relatively large braking torque is required by the driver of the vehicle traveling behind, the flashing frequency is increased, for example. Of course, increasing the flashing frequency makes sense only within physical limits (for example coefficient of friction, maximum deceleration which can be achieved by an average vehicle) and is therefore restricted to this range.

The invention describes a system in which the traffic traveling behind is observed and in the event of the risk of a rear-end crash a warning is issued if a collision can still only be prevented through severe braking of the traffic traveling behind. As a result, the severity of the accident can then possibly be reduced but the accident cannot be avoided in a relatively large number of cases. In order to avoid unnecessarily frequent warnings (incorrect warnings), according to one embodiment of the invention the warning will be issued only if the driver's own vehicle also brakes.

In order to increase further the number of accidents which are avoided, there is a need for a warning to be issued to the traffic traveling behind which can take place at an early time but does not disrupt the traffic. This can be done by means of a warning which the driver of the traffic traveling behind perceives only subconsciously (subliminally). This method of conveying information is known from subliminal advertizing (also known as sub-threshold advertizing) and it refers to a form of advertizing which can be perceived even when there is a heightened level of attention, for example because it is composed of very short, tachistoscopic, visual messages whose effectiveness can, however, be relied on. For the present invention a subliminal warning can be achieved by very brief flashing of the brake lights (a few milliseconds). In particular it is possible to provide that in the pre-warning mode (i.e., when a vehicle traveling behind approaches to a critical distance but the driver does not brake his own vehicle), the brake lights 7 will output the light signals according to a subliminal warning, as described in German patent document DE 19952408 A1.

In order to make the warning more intensive, it is also possible to provide that, in addition to the brake lights, the flashing hazard warning lights are also activated synchronously or alternately.

If the vehicle traveling behind (the following vehicle) has a predictive surroundings sensor system, in the event of a rear-end impact warning in the vehicle traveling in front, direct communication can be established between the surroundings sensor system of the vehicle traveling in front and the surroundings sensor system (for example radar sensor, distronic) of the following vehicle. In this case, the sensor system in the following vehicle is activated in such a way that a front impact warning is output and measures which are provided for that possibility, such as a warning to the driver or a braking intervention, are taken. Additionally or alternatively, corresponding threshold values can also be adapted. Although the surroundings sensor system of the following vehicle is according to regulations capable of outputting a rear-end impact warning if a vehicle approaches to a critical distance owing to braking of the vehicle traveling in front, this is sensed only when there is a certain degree of deceleration. In the refinement which is described above, the vehicle traveling behind is already informed at a very early time of an imminent braking maneuver of the vehicle traveling in front. This measure is therefore particularly suitable for the case of a vehicle approaching to a critical distance when at the same time there is a braking intervention (that is, when the brake lights emit a warning in the brake flashing mode).

At the same time as the information about a braking intervention, driving state data, for example relating to the state of the road or the coefficient of friction, can be transferred to the following vehicle from the vehicle traveling in front. The state of the road may therefore differ, for example depending on wetness, aquaplaning, ice, snow. Whenever the vehicle traveling in front brakes, the coefficient of friction is estimated. An average coefficient of friction over the total measurement and a minimum coefficient of friction (outlier) during the braking operation are determined and transferred. Sensor signals such as wheel slip, wheel speeds, ground speed, wheel speed accelerations, a_x sensor system are used to determine the coefficient of friction.

In addition, the immediately preceding course of the route can be taken into account. Since a portion of the adhesion potential of the tires is required for cornering (Kamm's Circle), it is necessary to take into account for the traffic traveling behind that a vehicle traveling behind cannot achieve the same deceleration values when braking on a corner as on a straight road. For this purpose, measurement variables such as steering wheel angle, lateral acceleration, wheel speeds and yaw rate which have been acquired during the braking operation or earlier can be used. This information is included in an n-dimensional characteristic diagram or table in order to define the information to be transferred there. It is also possible to transfer information about whether a limiting value of a brake pedal pressure or braking pressure or a gradient of these variables has been exceeded, or whether the ABS or ESP intervenes.

The possibility of issuing a warning over a communications link which is established between the rear-mounted surroundings sensor system of the vehicle traveling in front and a front-mounted surroundings sensor system in the following vehicle is always appropriate if the ranges of the transmitting and receiving systems of the two surroundings sensor systems permit it, and if communication can be established. This type of warning is therefore always possible even if a vehicle does not approach to a critical distance and/or a braking process does not occur or if only one of these two things applies.

This type of warning has the advantage that a following vehicle which is traveling closely behind can be conditioned in an optimum way to the section of the route ahead, which may be important in the case of emergency braking, so that an impact can still be prevented. It is therefore possible if a sudden drop in the coefficient of friction is registered in the vehicle traveling in front, that this information may already be available in the following vehicle before the vehicle reaches the jump in the coefficient of friction. As a result, for example, a premature warning or braking operation can be initiated in the following vehicle.

Overall, a multi-step rear-end impact warning for avoiding a rear-end crash or reducing the severity of an accident can be configured as follows:

Step I (pre-warning mode): very brief lighting up of the brake lights (for example LEDs) at a time at which the crash can be avoided without an excessively strong braking intervention by the vehicle traveling behind. The triggering can occur for the relative speed v_rel and/or distance with respect to the vehicle traveling behind when a threshold value is exceeded. The warning can be repeated many times. The renewed warning can be issued cyclically after a time period has expired and when there is still a hazard potential or when further predefined limiting values are exceeded.

If the driver's own vehicle does not brake or if its deceleration is below a threshold value, it is also possible to dispense with warning the traffic behind or the brake light may be actuated only to output brief light pulses, in the manner of a subliminal warning. This activation of the lights can be repeated periodically until the situation is clarified.

Step II (Second Pre-Warning Mode or Brake Flashing Mode):

Warning flashing of the brake lights at a time at which a rear-end crash can only still be prevented by means of a very strong braking intervention. At the same time, reversible pre-safe systems are activated (the window and sunroof close, etc.). The warning flashing is not switched off until after the hazardous situation has ended. The driver of the vehicle in question can be warned by means of a warning tone. The triggering criterion corresponds to that in step I, different threshold values applying.

The warning may be differentiate whether the driver's own vehicle is braking (brake flashing mode) or not braking (second pre-warning mode). The second pre-warning mode has a higher warning character than the first pre-warning mode of step I.

Step III: activation of further PRE-SAFE systems and pre-crash systems, triggering of the seat belt pretensioner and of the active head rest, pre-conditioning of the airbags if the crash can no longer be avoided.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-24. (canceled)

25. A motor vehicle having a rear-end impact warning device, which includes a surroundings sensor system, arranged at a rear end of the vehicle, that determines at least a distance to a following vehicle from backscattering of a signal and which rear-end impact warning device outputs light signals in a situation-dependent flashing mode by means of lights at the rear end of the vehicle, to provide traffic behind with a warning of a rear-end impact if the following vehicle approaches to within a critical distance; wherein:
the vehicle has a deceleration-sensing apparatus;
a flashing mode of said lights is predefined if a vehicle approaches to a critical distance while a braking process of the vehicle is occurring at the same time.

26. The motor vehicle as claimed in claim 25, wherein, if a motor vehicle approaches to within a critical distance and a braking process is not occurring, said lights do not output any light signals.

27. The motor vehicle as claimed in claim 25, wherein, if a motor vehicle approaches to within a critical distance and a braking process is not occurring, said lights output light signals in a pre-warning mode.

28. The motor vehicle as claimed in claim 25, wherein in the flashing mode luminous intensity of the lights is switched with a predefined flashing frequency between two luminous intensity levels L_b and L_c.

29. The motor vehicle as claimed in claim 28, wherein in the pre-warning mode the luminous intensity of the lights is switched with a predefined pre-warning frequency between 0 and a luminous intensity L_a.

30. The motor vehicle as claimed in claim 29, wherein at least two of the luminous intensity levels L_a, L_b, L_c differ from each other.

31. The motor vehicle as claimed in claim 30, wherein in the case of lights composed of a plurality of light units, different luminous intensity levels are achieved by actuating a proportion of the light units which corresponds to the desired luminous intensity.

32. The motor vehicle as claimed in claim 25, wherein:
the lights comprise two outer brake lights and a third brake light; and
in the brake flashing mode, the two outer brake lights and the third brake light are actuated with the cycles that are the same or opposing.

33. The motor vehicle as claimed in claim 27, wherein in the pre-warning mode, only the third brake light is actuated in a flashing fashion or continuously.

34. The motor vehicle as claimed in claim 32, wherein the third brake light comprises one of a middle brake light and a fog light.

35. The motor vehicle as claimed in claim 27, wherein the flashing patterns in the brake flashing mode and in the pre-warning mode differentiable based on a time period of the “ON” flashing phase.

36. The motor vehicle as claimed in claim 35, wherein, in the brake flashing mode the time period of an “ON” flashing phase is at least as long as that in the pre-warning mode.

37. The motor vehicle as claimed in claim 27, wherein the flashing patterns in the brake flashing mode and in the pre-warning mode are differentiable based on a time ratio between the “ON” and “OFF” flashing phases.

38. The motor vehicle as claimed in claim 37, wherein the time ratio between the “ON” and “OFF” flashing phases is >1 in the brake flashing mode and <1 in the pre-warning mode.

39. The motor vehicle as claimed in claim 27, wherein:
in the brake flashing mode and in the pre-warning mode, the flashing light signals are output with different frequencies; and
the frequency in the brake flashing mode is higher than in the pre-warning mode.

40. The motor vehicle as claimed in claim 25, wherein in one of the brake flashing mode and the pre-warning mode, the flashing light signals are output with a frequency which is approximately four times as high as the flashing frequency of a flashing hazard warning system which can be activated manually.

41. The motor vehicle as claimed in claim 27, wherein the vehicle indicates an emergency braking situation in the same brake flashing mode as the rear-end impact warning.

42. The motor vehicle as claimed in claim 27, wherein, in the pre-warning mode, the lights output light signals in a subliminal warning.

43. The motor vehicle as claimed in claim 25, wherein:
communication can be established with a surroundings sensor system of a following vehicle by means of the surroundings sensor system of the vehicle; and
a warning or conditioning of the following vehicle can occur by means of this communication link.

44. The motor vehicle as claimed in claim 43, wherein driving state data, in particular data relating to the braking intervention, the state of the road, the coefficient of friction or interventions in vehicle movement dynamics is transmissible via the communication link.

45. The motor vehicle as claimed in claim 25, wherein the flashing frequency and/or brightness of the light signals of the lights can be varied in accordance with the hazardous situation during a warning.

46. The motor vehicle as claimed in claim 25, wherein, when the vehicle approaches to a critical distance without carrying out a simultaneous braking process, a warning is output which differs from the brake flashing mode.

47. The motor vehicle as claimed in claim 25, wherein the braking process of the first vehicle is triggered by the driver or by a safety system, or can be caused by an engine drag torque or a climbing resistance.

48. The motor vehicle as claimed in claim 25, wherein:
the lights comprise at least one of brake lights or rear fog lights; and
the rear fog lights operable in a pulsed fashion.
